(19) United States
(12) Patent Application Publication
(10) Pub. No.: US 2018/0098090 A1
(43) Pub. Date: Apr. 5, 2018

(54) Method and Apparatus for Rearranging VR Video Format and Constrained Encoding Parameters

(71) Applicant: MEDIATEK INC., Hsin-Chu (TW)

(72) Inventors: Hung-Chih LIN, Hsin-Chu (TW); Jian-Liang LIN, Hsin-Chu (TW); Shen-Kai CHANG, Hsin-Chu (TW)

(21) Appl. No.: 15/722,734

(22) Filed: Oct. 2, 2017

Related U.S. Application Data
(60) Provisional application No. 62/403,732, filed on Oct. 4, 2016.

(51) Int. Cl. H04N 19/597; H04N 13/00; H04N 19/174; H04N 19/533; H04N 19/82; H04N 19/70

(52) U.S. Cl. CPC H04N 19/597; H04N 13/0029; H04N 13/0059; H04N 19/70; H04N 19/533; H04N 19/82; H04N 19/174

(57) ABSTRACT

Methods and apparatus for processing a 360°-VR frame sequence are disclosed. According to one method, input data associated with a 360°-VR frame sequence are received, where each 360°-VR frame comprises one set of faces associated with a polyhedron format. Each set of faces is rearranged into one rectangular whole VR frame consisting of a front sub-frame and a rear sub-frame, where the front sub-frame corresponds to first contents in a first field of view covering front 180°×180° view and the rear sub-frame corresponds to second contents in a second field of view covering rear 180°×180° view. Output data corresponding to a rearranged 360°-VR frame sequence consisting of a sequence of rectangular whole VR frames are provided.

### CROSS REFERENCE TO RELATED APPLICATIONS

The present invention claims priority to U.S. Provisional Patent Application, Ser. No. 62/403,732, filed on Oct. 4, 2016. The U.S. Provisional Patent Application is hereby incorporated by reference in its entirety.

### FIELD OF THE INVENTION

The present invention relates to 360-degree video. In particular, the present invention relates to rearranging a set of polyhedron faces of each 360°-VR frame from a 360° VR video sequence into a front view sub-frame and a rear view sub-frame. Video coding can be applied to the sub-frames of 360°-VR video sequence with constrained coding parameters.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a set of cameras, arranged to capture 360° field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

FIG. 1 illustrates an example of 360° VR image in a spherical coordinate. The z-axis corresponds to the polar axis and the plane perpendicular to the polar axis goes through the x-axis and the y-axis. A point P is the spherical coordinate is represented by (r, θ, φ), where r represents the distance of point P to the origin O, θ0 represents the zenith angle and φ represent the azimuth angle. The range for θ0 is from 0° to 180° and the range for φ is from 0° to 360°.

FIG. 2 illustrates an exemplary processing chain for converting a 360-degree spherical panoramic picture into a cubic-face frame. The 360° spherical panoramic pictures may be captured using a 360° spherical panoramic camera. Spherical image processing unit 210 accepts the raw image data from a 3D camera or cameras to form 360° spherical panoramic pictures. The spherical image processing may include image stitching and camera calibration. The spherical image processing is known in the field and the details are omitted in this disclosure. An example of 360°-spherical panoramic picture from the spherical image processing unit is shown in picture 212. The top side of the 360°-spherical panoramic picture corresponds to the vertical top (or sky) and the bottom side points to ground if the camera is oriented so that the top points up. However, if the camera is equipped with a gyro, the vertical top side can always be determined regardless how the camera is oriented. In the 360-degree spherical panoramic format, the contents in the scene appear to be distorted. Often, the spherical format is projected to the surfaces of a cube as an alternative 360° format. The conversion can be performed by a projection conversion unit 220 to derive the six face images 222 corresponding to the six faces of a cube 230. On the faces of the cube, these six images are connected at the edges of the cube.

Besides the cubic format, there are other polyhedron formats being used. FIG. 3 illustrates examples of polyhedron formats including cube format 310 (i.e., six faces), octahedron format 320, (i.e., eight faces) and icosahedron format 330 (i.e., twenty faces). The 3D images associated with various polyhedron formats can be converted into 2D images. For example, a net structure of the connected face images can be used for a 360° VR frame. In FIG. 3, the net structure of cube 315, the net structure of octahedron 325 and the net structure of icosahedron 335 are shown. FIG. 4 illustrates examples of net images associated with cube 412, octahedron 414 and icosahedron 416 corresponding to a 3D image in an equirectangular format 410.

As shown in the examples of FIG. 4, a 360° image represents a full field of view (FOV) of 360°×180° surrounding the 3D camera. The 3D images produce exceptional high-quality and high-resolution panoramic videos for use in print and panoramic virtual tour production. The 360°×180° images can be displayed on a 3D display device for a viewer to view the 360°×180° images. However, in practical uses, a viewer may only look at a partial view at a time such as a pre-determined ROI (region of interest) area in a front view or other area in a rear view. For example, in a music concert, the video contents for one single side (e.g. front FOV=180°×180°) in 360VR videos may be much more interesting than the other side (e.g. rear FOV=180°×180°). The front view mainly comprises players and/or singers and the rear view mainly comprises audience. In this example, a viewer will likely pay attention to the front view most of the time. In another example, the transmission bandwidth may be insufficient to transmit the whole 360 VR video bitstream. Therefore, there is a need to be able to deliver partial 360 VR video. The 360 VR video is also referred as 360° VR video in this disclosure.

Therefore, it is desirable to develop techniques to generate useable partial 360° VR video for practical use or bandwidth conservation.

### BRIEF SUMMARY OF THE INVENTION

Methods and apparatus for processing a 360° VR frame sequence are disclosed. According to one method, input data associated with a 360° VR frame sequence are received, where each 360° VR frame comprises one set of faces associated with a polyhedron format. Each set of faces is rearranged into one rectangular whole VR frame consisting of a front sub-frame and a rear sub-frame, where the front sub-frame corresponds to first contents in a first field of view covering front 180°×180° view and the rear sub-frame corresponds to second contents in a second field of view covering rear 180°×180° view. Output data corresponding to a rearranged 360° VR frame sequence consisting of a sequence of rectangular whole VR frames are provided.

The polyhedron format may correspond to a cube format with six faces, a regular octahedron format with eight faces or a regular icosahedron format with twenty faces. Each set of faces can be rearranged into one rectangular whole VR frame with or without blank areas. Each rectangular whole VR frame with blank areas can be derived from a net of polyhedron faces by fitting the net of polyhedron faces into a target rectangle, moving any face or any partial face outside the target rectangle into one un-used area within the target rectangle, and padding the blank areas. A target compact rectangle within the target rectangle can determined, and selected faces or partial faces of each rectangular whole VR frame with blank areas are moved to fill up the blank area to form one rectangular whole VR frame without blank areas. In one embodiment, the front sub-frame and the rear sub-frame correspond to the left and right halves of one rectangular whole VR frame, or top and bottom halves of one rectangular whole VR frame.

In one embodiment, the 360° VR frame sequence processing may further comprise encoding the rearranged 360° VR frame sequence into a compressed bitstream by processing a current front sub-frame in each rectangular whole VR frame using first reference data corresponding to one or more previously coded front sub-frames and processing a current rear sub-frame in each rectangular whole VR frame using second reference data corresponding to one or more previously coded rear sub-frames; and providing the compressed bitstream. Said encoding the rearranged 360° VR frame sequence may comprise partitioning each rectangular whole VR frame into two slices or two tiles corresponding to the front sub-frame and the rear sub-frame in each rectangular whole VR frame. Said encoding the rearranged 360° VR frame sequence may comprise performing integer motion search for the front sub-frame using only said one or more previously coded front sub-frames or performing the integer motion search for the rear sub-frame using only said one or more previously coded rear sub-frames. Said encoding the rearranged 360° VR frame sequence may comprise performing motion search for the front sub-frame using only said one or more previously coded front sub-frames, wherein any reference pixel outside one previously coded front sub-frame is replaced by one boundary pixel of said one previously coded front sub-frame; or performing the motion search for the rear sub-frame using only said one or more previously coded rear sub-frames, wherein any reference pixel outside one previously coded rear sub-frame is replaced by one boundary pixel of said one previously coded rear sub-frame.

Said encoding the rearranged 360° VR frame sequence may comprise performing an in-loop filter to reconstructed pixels of the front sub-frame or the rear sub-frame, and wherein the in-loop filter is disabled for boundary reconstructed pixels if the in-loop filter involves any pixel across a sub-frame boundary between the front sub-frame and the rear sub-frame. The in-loop filter may correspond to a de-blocking filter, SAO (Sample Adaptive Offset) filter or a combination thereof. Whether the in-loop filter is enabled can be indicated by one or more syntax elements in PPS (Picture Parameter Set), slice header or both. Said encoding the rearranged 360° VR frame sequence may comprise signaling one or more syntax elements to disable the in-loop filter.

A method of decoding 360°-VR frame sequence is also disclosed. A compressed bitstream associated with a 360°-VR frame sequence is received, where each 360°-VR frame comprises one set of faces associated with a polyhedron format. The compressed bitstream is decoded to reconstruct either a current front sub-frame or a current rear sub-frame for each 360°-VR frame according to view selection, where the current front sub-frame is decoded using first reference data corresponding to one or more previously coded front sub-frames and the current rear sub-frame is decoded using second reference data corresponding to one or more previously coded rear sub-frames. Either a front view corresponding to the current front sub-frame is displayed according to the view selection by rearranging the current front sub-frame into a set of front faces associated with a polyhedron format representing a first field of view covering front 180°×180° view or a rear view corresponding to the current front sub-frame is displayed according to the view selection by rearranging the current rear sub-frame into a set of rear faces associated with the polyhedron format representing a second field of view covering rear 180°×180° view. When the view selection is switched to a new view selection at a given 360°-VR frame, said decoding the compressed bitstream may start to reconstruct either a new front sub-frame or a new rear sub-frame according to the new view selection at an IDR (Instantaneous Decoder Refresh) 360°-VR frame.

### BRIEF DESCRIPTION OF THE DRAWINGS

FIG. 1 illustrates an example of 360°-VR image in a spherical coordinate, where the z-axis corresponds to the polar axis and the plane perpendicular to the polar axis goes through the x-axis and the y-axis.

FIG. 2 illustrates an exemplary processing chain for converting a 360-degree spherical panoramic picture into a cubic-face frame.

FIG. 3 illustrates examples of polyhedron formats including cube format (i.e., six faces), octahedron format, (i.e., eight faces) and icosahedron format (i.e., twenty faces).

FIG. 4 illustrates examples of net images corresponding to a 3D image in an equirectangular format for a cube, an octahedron and an icosahedron.

FIG. 5 illustrates an exemplary system according to an embodiment of the present invention to rearrange a 360°-VR frame into two sub-frames and to encode-decode the rearranged a 360°-VR frame.

FIG. 6 illustrates an example of two 180°×180° views (i.e., front and rear) from a viewer's standing point.

FIG. 7 illustrates an example of rearranging the 360 VR frame in the cube format into two sub-frames by partitioning the cube faces into front and rear halves.

FIG. 8 illustrates an example of rearranged sub-frames into a compact format, where the two half Left faces (i.e., face 2) are used to fill the blank areas in the middle top and middle bottom.

FIG. 9 illustrates another example of rearranged sub-frames in a compact format, where the two half Top faces (i.e., face 1) are used to fill the blank areas in the bottom.

FIG. 10 illustrates an example of rearranging the 360 VR frame in the octahedron format into two sub-frames by partitioning the faces into two halves (i.e., the front half and the rear half).

FIG. 11 illustrates an example of rearranging faces of an octahedron into two rearranged octahedron sub-frames without blank areas, where the movement of octahedron faces are indicated by the arrows in block.

FIG. 12 illustrates another example of rearranging faces of an octahedron into two rearranged octahedron sub-frames without blank areas, where the movement of octahedron faces in the first stage are indicated by the arrows.

FIG. 13 illustrates an example of rearranging the 360 VR frame in the icosahedron format into two sub-frames by partitioning the faces into two halves (i.e., the front half and the rear half). The rearranged icosahedron faces are padded with blank areas to form a rectangular frame.

FIG. 14 illustrates an example of rearrange faces of an icosahedron into two rearranged octahedron sub-frames without blank areas, where the movement of icosahedron faces are indicated by the arrows.

FIG. 15 illustrates examples of frame partition based on the slice structure according to an embodiment of the present invention.

FIG. 16 illustrates examples of frame partition based on the tile structure according to an embodiment of the present invention.

FIG. 17 illustrates an example of constrained motion search for integer motion vector, where a current frame is partitioned into tile #0 corresponding to front view and tile #1 corresponding to rear view.

FIG. 18 illustrates an example of constrained motion search for fractional-pel motion vector. For fractional-pel motion search, interpolation is used to derive the fractional-pel motion vector.

FIG. 19 illustrates an example of decoding process with a selected view according to an embodiment of the present invention.

FIG. 20 illustrates an exemplary flowchart of a system that rearranges a 360 VR frame into sub-frames corresponding to a front view and a rear view according to an embodiment of the present invention.

FIG. 21 illustrates an exemplary flowchart of a 360°-VR decoding system that uses rearranged 360 VR frames according to an embodiment of the present invention.

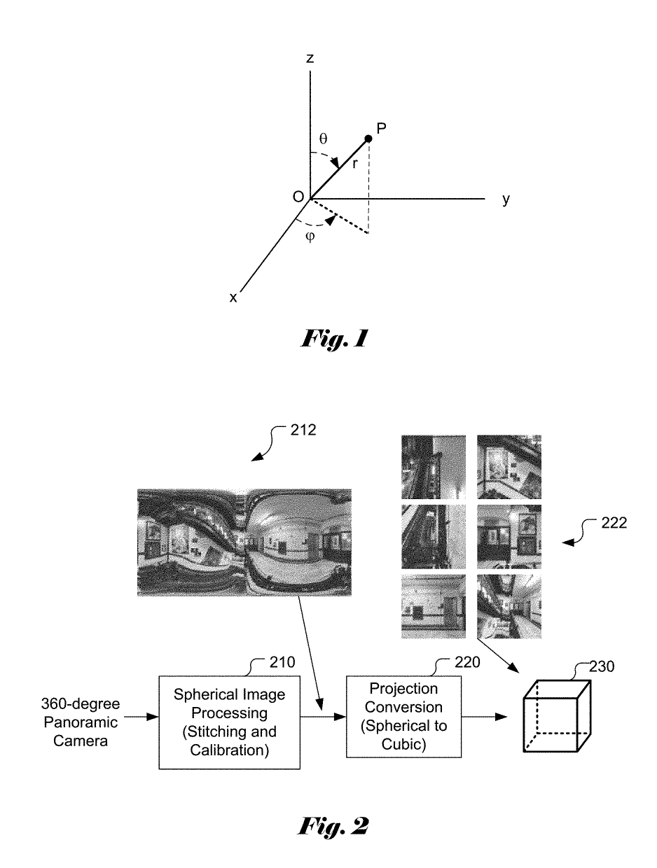

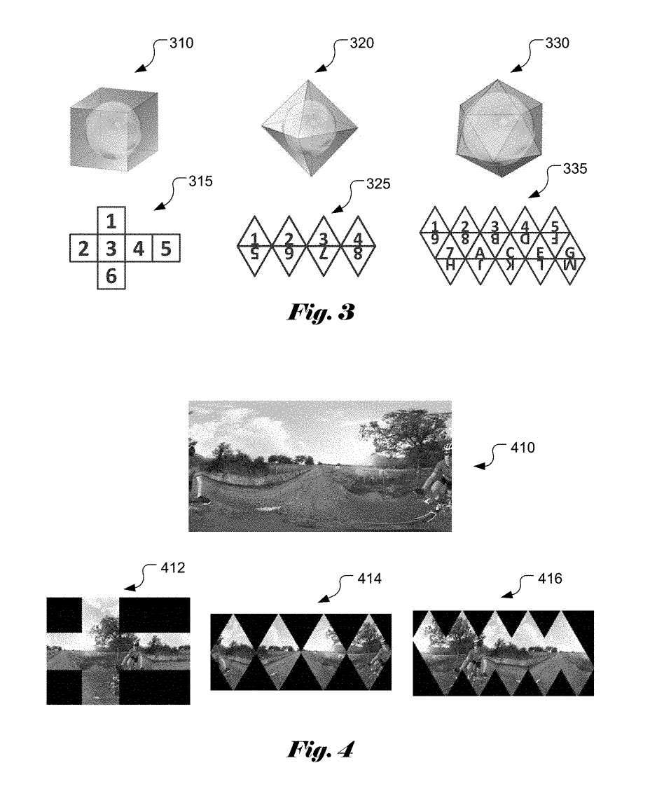

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

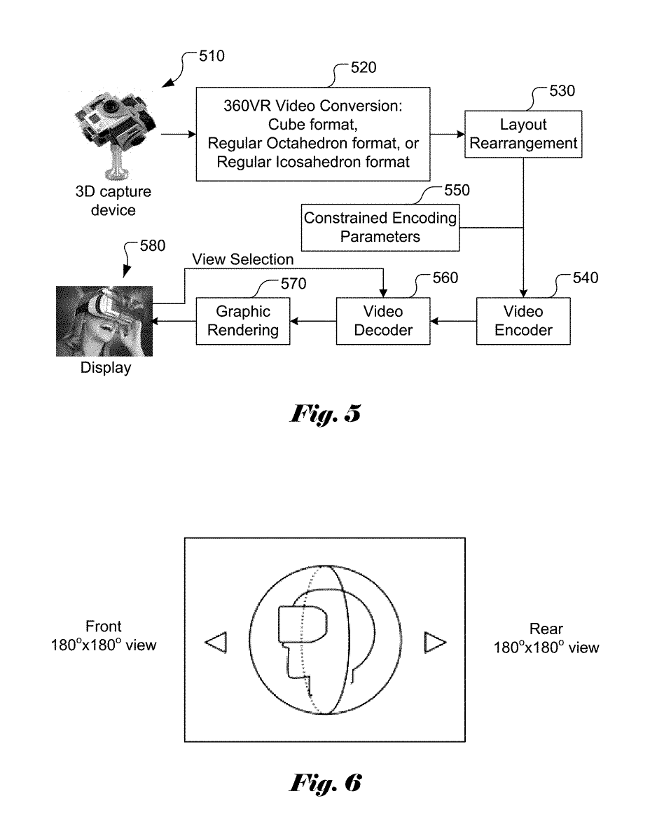

As mentioned before, in some applications, a whole 360° view may not be needed to present to a viewer at the same time. If the 360° view video data can be properly arranged, it is possible to provide partial view data as needed. Therefore, only data associated with a partial view need to be retrieved, processed, displayed or transmitted. Accordingly, the present invention discloses a method to rearrange the 360° view video data so that partial view data (e.g. front view or rear view) can be retrieved, processed, displayed or transmitted. An example of system block diagram according to the present invention is shown in FIG. 5, where a 3D capture device 510 provides captured VR to 360 VR Video Conversion unit 520, which converts VR video frames into a polyhedron format such as cube format, octahedron format or icosahedron format. Partial view data associated with a polyhedron format are then generated using Layout Rearrangement unit 530. Partial view data associated with a polyhedron format can be stored or transmitted.

Since the amount of VR video data is typically very large, it is desirable to compress the data before the data are stored or transmitted. Accordingly, a Video Encoder 540 is shown to compress the output data from the Layout Rearrangement unit 530. After rearrangement, the partial view data is not omnidirectional any more. In this case, some coding operations, such as motion estimation and compensation, will be restricted to certain areas. Information related to coding constraints can be determined according to the layout rearrangement process and Constrained Coding Parameters 550 can be provided to the Video Encoder 540 for proper encoding process. The output from the Video Encoder 540 can be stored or transmitted (e.g. through streaming media). The link for transmission or storage is not shown in the signal processing chain in FIG. 5.

At the viewer end, the compressed data is received from a transmission link or network, or read from storage. The compressed data are then decoded using Video Decoder 560 to reconstruct the partial view data. The reconstructed the partial view data is then rendered using Graphic Rendering unit 570 to generate suited VR data for displaying on a Display device 580. According to the present invention, the whole 360 VR video may be separated into partial view videos. Upon a selected view, a corresponding partial view can be transmitted/retrieved and decoded. The View Selection information can be provided to the Video Decoder 570 to reconstruct the needed partial view data.

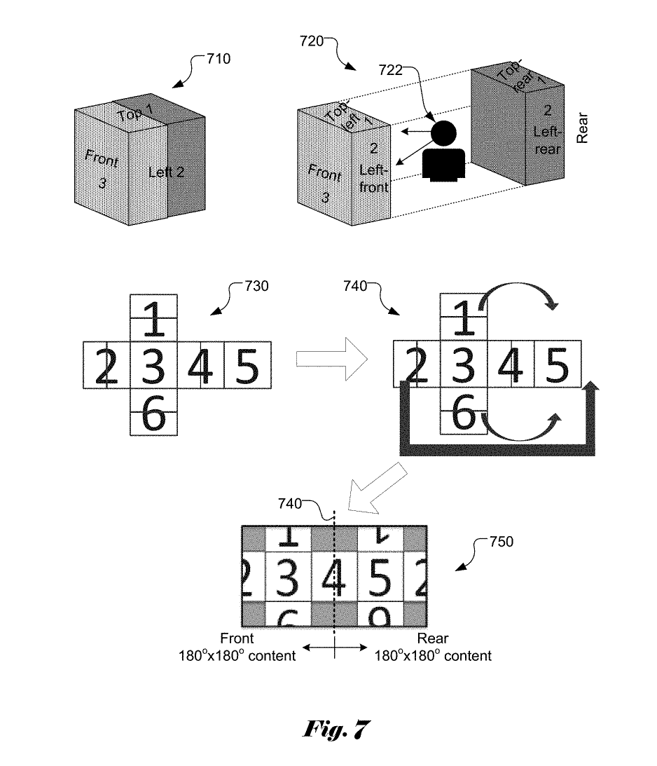

The Layout Rearrangement unit 520 receives a 360 VR video sequence comprising 360 VR video frames in a selected polyhedron format. Each video frame represents contents in a 360°×180° view surrounding the capture device. According to one embodiment of the present invention, each 360 VR video frame is rearranged into two separate 180°×180° sub-frames, where one corresponds to the front 180°×180° contents and the other represents the rear 180°×180° contents. These two sub-frames form a whole video frame for encoding. The rearranged layout may have two possible types: non-compact type (i.e., video frame with blank areas) and compact type, (i.e., video frame without blank area). The information of the rearranged layout can be signaled in the bitstream or pre-defined so that a decoder can properly derive a whole frame from sub-frames. FIG. 6 illustrates an example of two 180°×180° views (i.e., front and rear) from a viewer's standing point.

FIG. 7 illustrates an example of rearranging the 360 VR frame in the cube format into two sub-frames by partitioning the cube faces into two halves (i.e., the front half and the rear half). Cube 710 consists of six faces and three visible faces from the current viewing angle are labels as Top (1), Left (2) and Front (3). The other three faces invisible correspond to Rear (5), Bottom (6) and Right (4). The cube is partitioned into two halves (720) corresponding to front view and rear view from the viewer's position (722). The six cube faces are shown in block 730, where the faces that are partitioned (i.e., faces 1, 2, 4 and 6) into two views are indicated by partition lines through the cube faces. The rearrangement according to an embodiment of the present invention is illustrated in block 740, where the arrows indicate the image movement. For example, the upper half of cube image 1 is rotated by 180° and then placed on top of cube image 5. After rearrangement, the rearranged whole 360 VR frame is shown in block 750, where blank areas are shown as gray color. The rearranged whole 360 VR frame can be split in the middle as shown by the dashed line 755 to separate it into two sub-frames corresponding to the front view and the rear view.

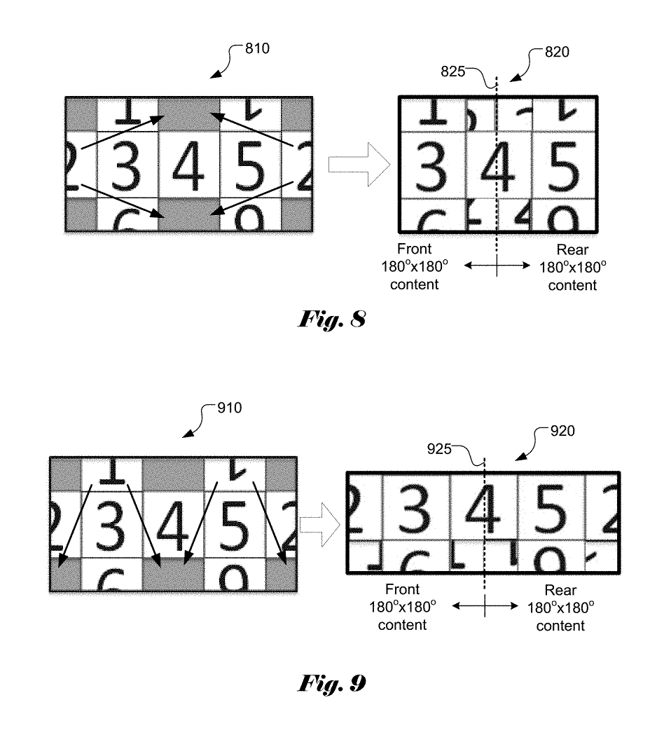

The rearranged 360 VR frame as shown in block 750 includes blank area. According to another embodiment, a compact format is disclosed, which remove the blank areas. FIG. 8 illustrates an example of rearranged sub-frames into a compact format, where the two half Left faces (i.e., face 2) are used to fill the blank areas in the middle top and middle bottom. Arrows in block 810 indicate the rearrangement for the two half Left faces (i.e., face 2) and block 820 illustrates the rearranged sub-frames without any blank areas, where the frame can be partitioned into two sub-frames along the dashed line 825. FIG. 9 illustrates another example of rearranged sub-frames in a compact format, where the two half Top faces (i.e., face 1) are used to fill the blank areas in the bottom. Arrows in block 910 indicate the movement for the two half Top faces (i.e., face 1) and block 920 illustrates the rearranged sub-frames without any blank area, where the frame can be partitioned into two sub-frames along the dashed line 925.

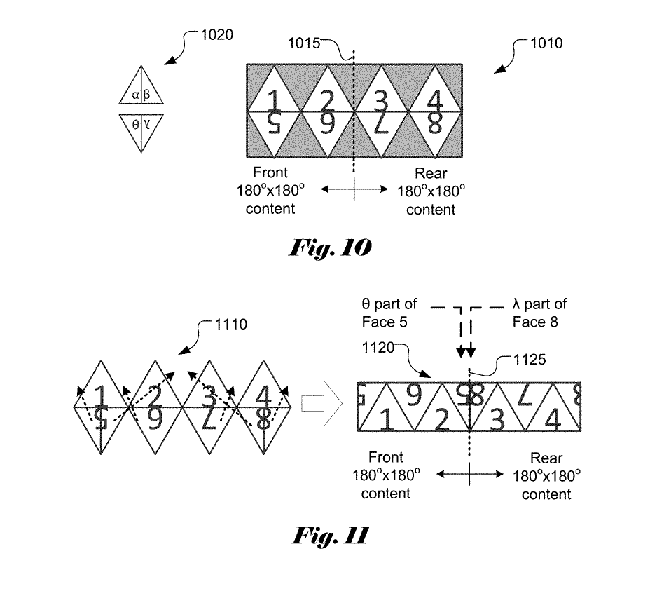

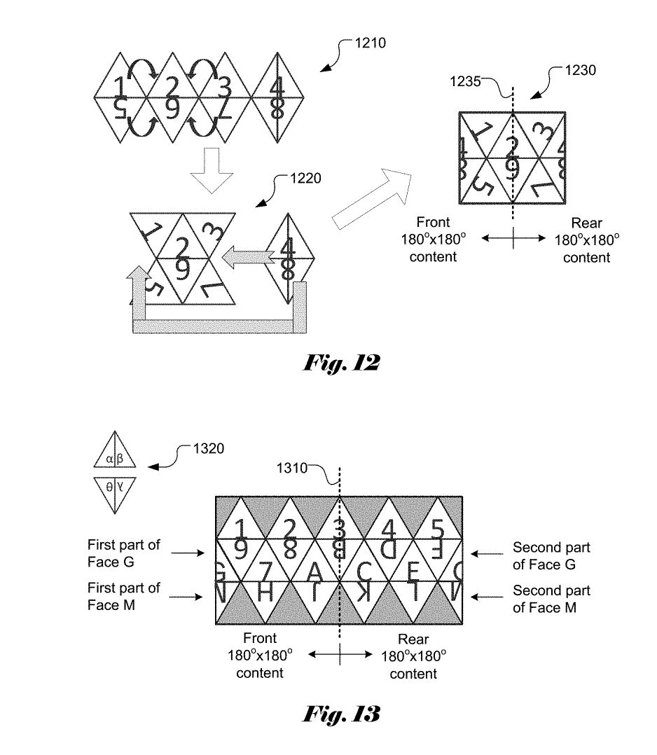

FIG. 10 illustrates an example of rearranging the 360 VR frame in the octahedron format into two sub-frames by partitioning the faces into two halves (i.e., the front half and the rear half). The rearranged octahedron faces are padded with blank areas to form a rectangular frame. The rearranged frame can be split in the middle as indicated by the dashed line 1015 to form a front view and a rear view. In order to reference the face that may have to be rearranged to form a compact format, four parts of each pair of triangle faces are designated with individual part references (i.e., α, β, λ and θ) as shown in block 1020. FIG. 11 illustrates an example of rearranging faces of an octahedron into two rearranged octahedron sub-frames without blank areas, where the movement of octahedron faces are indicated by the arrows in block 1110. Block 1120 illustrates the rearranged whole 360 VR frame associated with the octahedron format. The rearranged whole 360 VR frame is readily split in the middle as shown by the dashed line 1125 into two sub-frames corresponding to a front view and a rea view. FIG. 12 illustrates another example of rearranging faces of an octahedron into two rearranged octahedron sub-frames without blank areas, where the movement of octahedron faces in the first stage are indicated by the arrows in block 1210. Block 1220 illustrates an intermediate stage of rearrangement for the octahedron, where faces 4 and 8 are further split into a left half and a right half to fit into the concave un-occupied areas of the intermediate frame as indicated by the arrows in block 1220. Block 1230 illustrates the rearranged whole 360 VR frame associated with the octahedron format. The rearranged whole 360 VR frame can be readily split from the middle as indicated by the dashed line 1235 into two sub-frames corresponding to a front view and a rea view.

FIG. 13 illustrates an example of rearranging the 360 VR frame in the icosahedron format into two sub-frames by partitioning the faces into two halves (i.e., the front half and the rear half). The rearranged icosahedron faces are padded with blank areas to form a rectangular frame. In FIG. 13, faces G and M at the left and right edges of the frame are split in order to conserve space. The rearranged frame can be split in the middle as indicated by the dashed line 1310 to form a front view and a rear view. In order to reference the face that may have to be rearranged to form a compact format, four parts of each pair of triangle faces are designated with individual part references (i.e., α, β, λ and θ) as shown in block 1320. FIG. 14 illustrates an example of rearrange faces of an icosahedron into two rearranged octahedron sub-frames without blank areas, where the movement of icosahedron faces are indicated by the arrows in block 1410. Block 1420 illustrates the rearranged whole 360 VR frame associated with the octahedron format. The rearranged whole 360 VR frame can be readily split from the middle as indicated by the dashed line 1425 into two sub-frames corresponding to a front view and a rea view.

According to one embodiment of the present invention, video data of the rearranged face layout corresponding to a front view and a rear view is provided to a video encoder for video compression. One of the intended applications is to allow video data associated with a partial view to be retrieved or displayed without the need to access the whole-view video data. Therefore, certain constraints may have to be applied in order to achieve this goal.

Accordingly, the video encoder according to an embodiment of the present invention incorporates one or more of the following constraints:
Constraint #1: Encode the frame by partitioning the frame into two frame partitions (e.g. slice or tile) aligned with the sub-frame structure mentioned above. For example, one frame partition corresponds to front 180°×180° view and the other corresponds to rear 180°×180° view.
Constraint #2: Disable in-loop filter control for pixel data across frame partition boundary.
Constraint #3: Constrain motion search. For example, when the integer motion is used, the reference area of front view (or rear view) pointed by an integer motion should not access the other frame partition region. When fractional-pel motion is used, the reference area of front view (or rear view) pointed by a fractional-pel motion is produced by interpolating neighboring integer pixel data. Thus, a fractional-pel motion that uses neighboring pixels data located at the other frame partition is not allowed to be a motion candidate.
Constraint #4: Insert periodic IDR (Instantaneous Decoder Refresh) frame for a user to switch between front and rear views at an IDR frame.

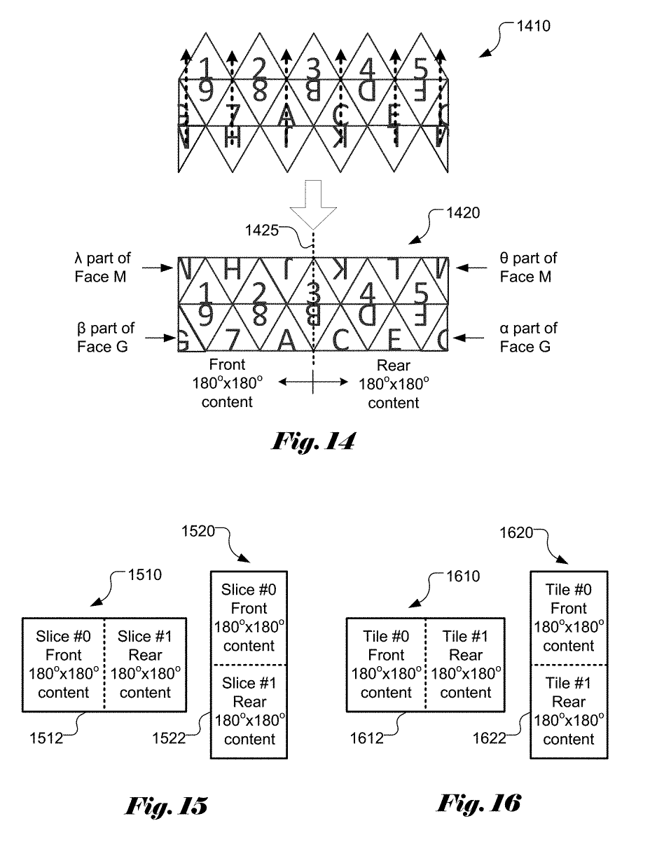

For frame partition, one embodiment of the present invention utilizes the slice or tile structure to partition a frame into two frame partitions (i.e., two slices or two tiles) aligned with the two sub-frames corresponding to a front view and a rear view. The slice and tile structure has been widely used in various video standards. For example, the slice structure is supported by MPEG-1/2/4, H.264 and H.265 and the tile structure is supported by H.265, VP9, and AV1. FIG. 15 illustrates examples of frame partition based on the slice structure according to an embodiment of the present invention. In block 1510, the whole frame 1512 is partitioned into a left slice and a right slice corresponding to the contents of front 180°×180° view and rear 180°×180° view respectively. In block 1520, the whole frame 1522 is partitioned into a top slice and a bottom slice corresponding to the contents of front 180°×180° view and rear 180°×180° view respectively. FIG. 16 illustrates examples of frame partition based on the tile structure according to an embodiment of the present invention. In block 1610, the whole frame 1612 is partitioned into a left tile and a right tile corresponding to the contents of front 180°×180° view and rear 180°×180° view respectively. In block 1620, the whole frame 1622 is partitioned into a top tile and a bottom tile corresponding to the contents of front 180°×180° view and rear 180°×180° view respectively.

FIG. 17 illustrates an example of constrained motion search for integer motion vector. In FIG. 17, frame 1710 corresponds to the current frame, which is partitioned into tile #0 corresponding to front view (1712) and tile #1 corresponding to rear view (1714). Frame 1720 corresponds to a reference frame, which is also partitioned into tile #0 corresponding to front view (1722) and tile #1 corresponding to rear view (1724). According to an embodiment of the present invention, the current tile #0 (1712) only searches the corresponding reference area (i.e., tile #0 corresponding to front view (1722)) and the current tile #1 (1714) only searches the corresponding reference area (i.e., tile #1 corresponding to front view (1724)). When required tile #0 reference data (or required tile #1 reference data) is outside the tile #0 sub-frame (or tile #1 sub-frame), various existing techniques can be used to handle this situation. For example, the reference data outside the reference sub-frame can be created by using padding.

FIG. 18 illustrates an example of constrained motion search for fractional-pel motion vector. For fractional-pel motion search, interpolation is used to derive the pixel data for the fractional-pel motion vector. Therefore, additional reference data beyond the corresponding reference area will be needed. For example, if a 6-tap filter adopted by H.264 or 8-tap filter adopted by HEVC is used, 3-pixel or 4-pixel wide reference data around the reference boundaries will be need. Accordingly, the required tile #0 reference data would have to extend into tile #1 reference area. According to an embodiment of the present invention, tile #0 (or tile #1) only uses reference data from tile #0 reference sub-frame (or tile #1 reference sub-frame). Accordingly, some reference data at fractional-pel positions near the sub-frame boundary are not available for fractional-pel motion vector derivation. In FIG. 18, frame 1810 corresponds to the current frame, which is partitioned into tile #0 corresponding to front view (1812) and tile #1 corresponding to rear view (1814). Frame 1820 corresponds to the reference frame, which is partitioned into tile #0 corresponding to front view (1822) and tile #1 corresponding to rear view (1824). According to an embodiment of the present invention, the current tile #0 (1812) only searches the corresponding reference area (i.e., tile #0 corresponding to front view (1822)) and the current tile #1 (1814) only searches the corresponding reference area (i.e., tile #1 corresponding to front view (1824)). In addition, n-pixel lines (n=3 for H.264 and n=4 for HEVC) at the sub-frame boundary are not available for fractional-pel positions. Again, when required tile #0 reference data (or required tile #1 reference data) is outside the tile #0 sub-frame (or tile #1 sub-frame), various existing techniques can be used to handle this situation. For example, the reference data outside the reference sub-frame can be created by using padding.

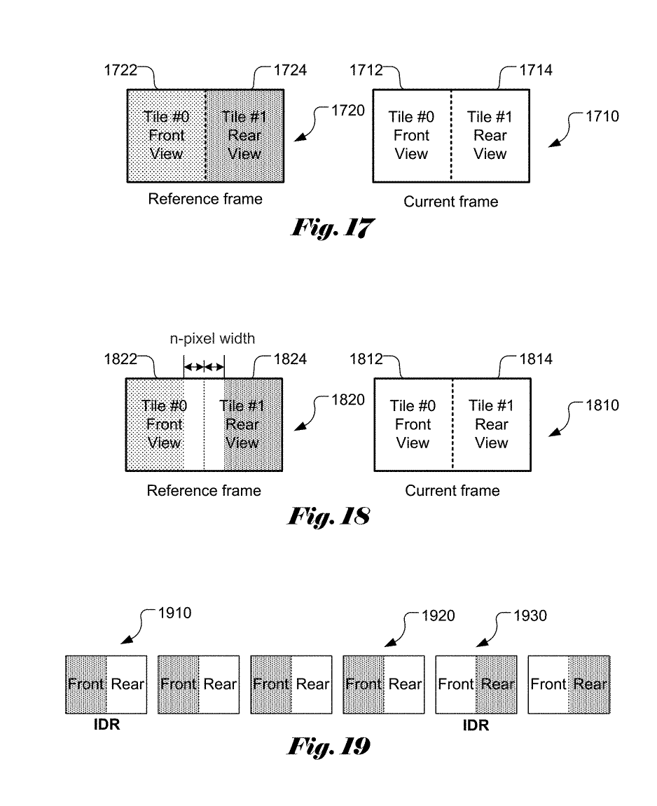

When the compressed VR data is displayed, the compressed VR data have to be decoded first. Since the VR video compression according to the present invention uses frame partition to allow individual front view or rear view processing. Accordingly, the decoding process can be dependent on the selected view (i.e., front view or rear view). In one embodiment, a VR encoder may insert IDR frame periodically or as needed to allow a viewer to switch selected view. An example of decoding process with a selected view according to an embodiment of the present invention is shown in FIG. 19. In this example, the front view is initially selected and the front view of the first IDR frame 1910 is decoded, where the sub-frame in gray indicates the view being decoded. If the viewer decides to switch to the rear view during decoding the front view for frame 1920, the decoding switches to the rear view at the next IDR frame 1930.

In advanced video coding, various in-loop filters have been used to improve the visual quality and/or to reduce bitrate. Often, the in-loop filter will utilize neighboring pixel data. In other words, at sub-frame boundary, the in-loop filter may depend on pixel data from the other sub-frame. In order to allow one view decoded properly without the dependency on the other view, in-loop filtering across sub-frame boundary is disabled. The use of in-loop filter control can be identified from control syntax elements. For example, in H.264, in-loop filter control element deblocking_filter_control_present_flag is signaled in the picture parameter set (PPS) and disable_deblocking_filter_idc is signal in the slice header to control whether to apply deblocking filter. In HEVC, both de-blocking filter and SAO (sample adaptive offset) filter are used. For example, tiles_enabled_flag,_loop_filter_across_tiles_enabled_flag, pps_loop_filter_across_slices_enabled_flag, deblocking_filter_control_present_flag, deblocking_filter_override_enabled_flag and pps_deblocking_filter_disabled _flag are signaled in the PPS. Also slice level filter controls are used, such as deblocking_filter_override_flag, slice_deblocking_filter_disabled_flag and slice_loop_filter_across_slices_enabled_flag. According to an embodiment of the present invention, the dependency of in-loop filter between frame partitions can be removed by disabling in-loop filter for pixel locations where the in-loop filter will cross the sub-frame boundary. For example, the in-loop filter for pixel locations across the slice boundary can be disabled for H.264 by setting disable_deblocking_filter_idc to 2 for deblocking_filter_control_present_flag=1. In another example, in-loop filter can be disabled for pixel location where the in-loop filter with go across the tile boundary for H.265 by setting tiles_enabled_flag=1 and loop_filter_across_tiles_enabled_flag=0.

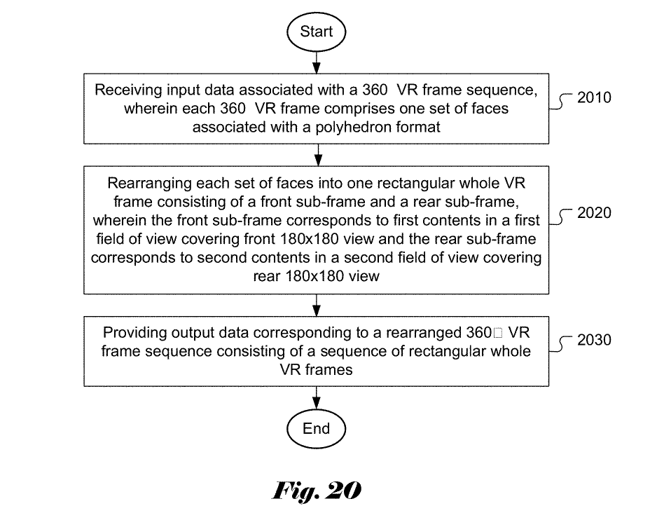

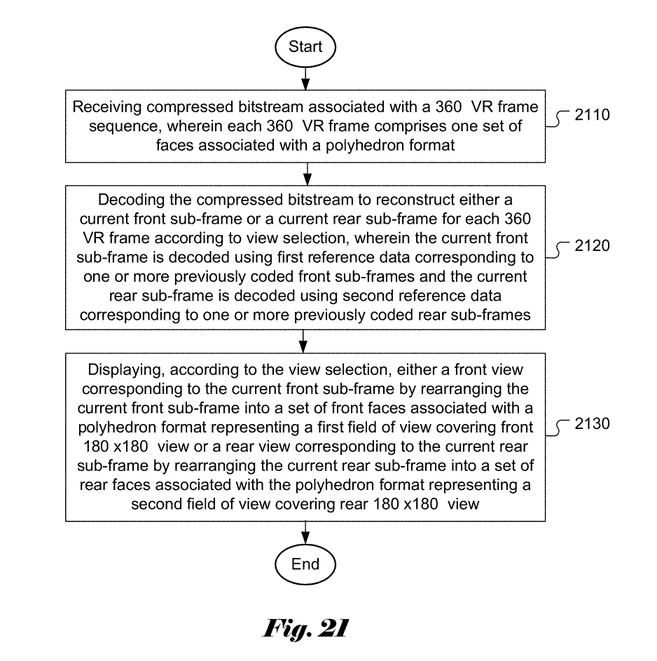

FIG. 20 illustrates an exemplary flowchart of a system that rearranges a 360 VR frame into sub-frames corresponding to a front view and a rear view according to an embodiment of the present invention. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, input data associated with a 360°-VR frame sequence are received in step 2010, wherein each 360°-VR frame comprises one set of faces associated with a polyhedron format. Each set of faces is rearranged into one rectangular whole VR frame consisting of a front sub-frame and a rear sub-frame in step 2020, wherein the front sub-frame corresponds to first contents in a first field of view covering front 180°×180° view and the rear sub-frame corresponds to second contents in a second field of view covering rear 180°×180° view. Various examples of rearranging 360°-VR frame from polyhedron faces into sub-frames are shown in FIG. 7 through FIG. 14. Data corresponding to a rearranged 360°-VR frame sequence consisting of a sequence of rectangular whole VR frames are provided in step 2030. The provided data can be used for compression.

FIG. 21 illustrates an exemplary flowchart of a 360°-VR decoding system that uses rearranged 360 VR frames according to an embodiment of the present invention. A compressed bitstream associated with a 360°-VR frame sequence is received in step 2110, wherein each 360°-VR frame comprises one set of faces associated with a polyhedron format. The compressed bitstream is decoded to reconstruct either a current front sub-frame or a current rear sub-frame for each 360°-VR frame according to view selection in step 2120, wherein the current front sub-frame is decoded using first reference data corresponding to one or more previously coded front sub-frames and the current rear sub-frame is decoded using second reference data corresponding to one or more previously coded rear sub-frames. In step 2130, according to the view selection, either a front view corresponding to the current front sub-frame by rearranging the current front sub-frame into a set of front faces associated with a polyhedron format representing a first field of view covering front 180°×180° view is display or a rear view corresponding to the current rear sub-frame by rearranging the current rear sub-frame into a set of rear faces associated with the polyhedron format representing a second field of view covering rear 180°×180° view is displayed.

The flowchart shown above is intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing a 360° VR frame sequence, the method comprising:
receiving input data associated with a 360° VR frame sequence, wherein each 360° VR frame comprises one set of faces associated with a polyhedron format;
rearranging each set of faces into one rectangular whole VR frame consisting of a front sub-frame and a rear sub-frame, wherein the front sub-frame corresponds to first contents in a first field of view covering front 180°×180° view and the rear sub-frame corresponds to second contents in a second field of view covering rear 180°×180° view; and
providing output data corresponding to a rearranged 360° VR frame sequence consisting of a sequence of rectangular whole VR frames.

2. The method of claim 1, wherein the polyhedron format corresponds to a cube format with six faces, a regular octahedron format with eight faces or a regular icosahedron format with twenty faces.

3. The method of claim 1, wherein each set of faces is rearranged into one rectangular whole VR frame with or without blank areas.

4. The method of claim 3, wherein each rectangular whole VR frame with blank areas is derived from a net of polyhedron faces by fitting the net of polyhedron faces into a target rectangle, moving any face or any partial face outside the target rectangle into one un-used area within the target rectangle, and padding the blank areas.

5. The method of claim 3, wherein a target compact rectangle within the target rectangle is determined, and selected faces or partial faces of each rectangular whole VR frame with blank areas are moved to fill up the blank area to form one rectangular whole VR frame without blank areas.

6. The method of claim 1, wherein the front sub-frame and the rear sub-frame correspond to left and right halves of one rectangular whole VR frame, or top and bottom halves of one rectangular whole VR frame.

7. The method of claim 1 further comprising encoding the rearranged 360° VR frame sequence into a compressed bitstream by processing a current front sub-frame in each rectangular whole VR frame using first reference data corresponding to one or more previously coded front sub-frames and processing a current rear sub-frame in each rectangular whole VR frame using second reference data corresponding to one or more previously coded rear sub-frames; and providing the compressed bitstream.

8. The method of claim 7, wherein said encoding the rearranged 360° VR frame sequence comprises partitioning each rectangular whole VR frame into two slices or two tiles corresponding to the front sub-frame and the rear sub-frame in each rectangular whole VR frame.

9. The method of claim 7, wherein said encoding the rearranged 360° VR frame sequence comprises performing integer motion search for the front sub-frame using only said one or more previously coded front sub-frames or performing the integer motion search for the rear sub-frame using only said one or more previously coded rear sub-frames.

10. The method of claim 7, wherein said encoding the rearranged 360° VR frame sequence comprises performing fractional-pel motion search for the front sub-frame using only said one or more previously coded front sub-frames less a plurality of boundary lines between the front sub-frame and the rear sub-frame, or performing the fractional-pel motion search for the rear sub-frame using only said one or more previously coded rear sub-frames less the plurality of boundary lines between the front sub-frame and the rear sub-frame.

11. The method of claim 7, wherein said encoding the rearranged 360° VR frame sequence comprises performing motion search for the front sub-frame using only said one or more previously coded front sub-frames, wherein any reference pixel outside one previously coded front sub-frame is replaced by one boundary pixel of said one previously coded front sub-frame; or performing the motion search for the rear sub-frame using only said one or more previously coded rear sub-frames, wherein any reference pixel outside one previously coded rear sub-frame is replaced by one boundary pixel of said one previously coded rear sub-frame.

12. The method of claim 7, wherein said encoding the rearranged 360° VR frame sequence comprises performing an in-loop filter to reconstructed pixels of the front sub-frame or the rear sub-frame, and wherein the in-loop filter is disabled for boundary reconstructed pixels if the in-loop filter involves any pixel across a sub-frame boundary between the front sub-frame and the rear sub-frame.

13. The method of claim 12, wherein the in-loop filter corresponds to a de-blocking filter, SAO (Sample Adaptive Offset) filter or a combination thereof.

14. The method of claim 12, wherein whether the in-loop filter is enabled is indicated by one or more syntax elements in PPS (Picture Parameter Set), slice header or both.

15. The method of claim 7, wherein said encoding the rearranged 360° VR frame sequence comprises signaling one or more syntax elements to disable in-loop filter.

16. An apparatus for processing a 360° VR frame sequence, the apparatus comprising one or more electronic circuits or processors arranged to:
receive input data associated with a 360° VR frame sequence, wherein each 360° VR frame comprises one set of faces associated with a polyhedron format;
rearrange the set of faces into a rectangular whole VR frame consisting of a front sub-frame and a rear sub-frame, wherein the front sub-frame corresponds to first contents in a first field of view covering front 180°×180° view and the rear sub-frame corresponds to second contents in a second field of view covering rear 180°×180° view; and
provide output data corresponding to a rearranged 360° VR frame sequence consisting of a sequence of rectangular whole VR frames.

17. The apparatus of claim 16, the apparatus is further arranged to encode the rearranged 360° VR frame sequence into a compressed bitstream by processing a current front sub-frame in each rectangular whole VR frame using first reference data corresponding to one or more previously coded front sub-frames and processing a current rear sub-frame in each rectangular whole VR frame using second reference data corresponding to one or more previously coded rear sub-frames; and provide the compressed bitstream.

18. A method of decoding 360° VR frame sequence, the method comprising:
receiving compressed bitstream associated with a 360° VR frame sequence, wherein each 360° VR frame comprises one set of faces associated with a polyhedron format;
decoding the compressed bitstream to reconstruct either a current front sub-frame or a current rear sub-frame for each 360° VR frame according to view selection, wherein the current front sub-frame is decoded using first reference data corresponding to one or more previously coded front sub-frames and the current rear sub-frame is decoded using second reference data corresponding to one or more previously coded rear sub-frames; and
displaying, according to the view selection, either a front view corresponding to the current front sub-frame by rearranging the current front sub-frame into a set of front faces associated with a polyhedron format representing a first field of view covering front 180°×180° view or a rear view corresponding to the current rear sub-frame by rearranging the current rear sub-frame into a set of rear faces associated with the polyhedron format representing a second field of view covering rear 180°×180° view.

19. The method of claim 18, wherein when the view selection is switched to a new view selection at a given 360° VR frame, said decoding the compressed bitstream starts to reconstruct either a new front sub-frame or a new rear sub-frame according to the new view selection at an IDR (Instantaneous Decoder Refresh) 360° VR frame.
